(19) United States
(12) Patent Application Publication
(10) Pub. No.: US 2022/0319109 A1
(43) Pub. Date: Oct. 6, 2022

(54) COMPLETING POINT CLOUD DATA AND PROCESSING POINT CLOUD DATA

(71) Applicant: SENSETIME INTERNATIONAL PTE. LTD., Singapore (SG)

(72) Inventors: Junzhe ZHANG, Singapore (SG); Xinyi CHEN, Singapore (SG); Zhongang CAI, Singapore (SG); Haiyu ZHAO, Singapore (SG); Shuai YI, Singapore (SG)

(21) Appl. No.: 17/362,726

(22) Filed: Jun. 29, 2021

Related U.S. Application Data
(63) Continuation of application No. PCT/IB2021/054749, filed on May 31, 2021.

(30) Foreign Application Priority Data
Mar. 30, 2021 (SG) 10202103258S

(51) Int. Cl. G06T 17/00; G06N 3/08; G06N 3/04

(52) U.S. Cl. CPC G06T 17/00; G06N 3/08; G06N 3/0454

(57) ABSTRACT

The embodiments of the present disclosure provide a method, an apparatus and a system for completing point cloud data and a method, an apparatus and a system for processing point cloud data. The method includes: acquiring first point cloud data; acquiring second point cloud data by completing the first point cloud data with a point cloud completion network, wherein, the point cloud completion network is trained based on complete point cloud data and configured to generate third point cloud data according to target latent space vector, and a difference between fourth point cloud data acquired from the third point cloud data by performing preset degradation and real point cloud data collected from a physical space is within a preset difference range.

### CROSS-REFERENCE TO RELATED APPLICATIONS

The present application is a continuation of International Application No. PCT/IB2021/054749 filed on May 31, 2021, which claims priority to Singapore Patent Application No. 10202103258S, filed on Mar. 30, 2021, all of which are incorporated herein by reference in their entirety.

### TECHNICAL FIELD

The present disclosure relates to the field of computer vision technology, in particular to methods, apparatuses and systems for completing point cloud data and methods, apparatuses and systems for processing point cloud data.

### BACKGROUND

Point cloud completion is used to repair point cloud data which has lost some (that is, incomplete point cloud data or defect point cloud data), and estimate complete point cloud data based on the incomplete point cloud data. Point cloud completion has been applied in many fields such as autonomous driving and robot navigation. Traditional methods of point cloud completion mostly perform fully supervised training on a point cloud completion network with training data including point cloud pairs composed of incomplete point cloud data and complete point cloud data, and then complete incomplete point cloud data with the trained point cloud completion network. However, a point cloud completion network obtained through the above methods is difficult to generalize to other forms of incomplete point cloud data, and generalization performance of which is poor as forms of incomplete point cloud data are often diverse due to various types of sensors or occlusions.

### SUMMARY

The present disclosure provides a method, an apparatus and a system for completing point cloud data and a method, an apparatus and a system for processing point cloud data.

According to a first aspect of the embodiments of the present disclosure, a method of completing point cloud data is provided, including: acquiring first point cloud data; acquiring second point cloud data by completing the first point cloud data with a point cloud completion network; wherein, the point cloud completion network is trained based on complete point cloud data and configured to generate third point cloud data according to target latent space vector, and a difference between fourth point cloud data acquired from the third point cloud data by performing preset degradation and real point cloud data collected from a physical space is within a preset difference range.

In some embodiments, the method further includes: acquiring raw point cloud data collected by a point cloud collecting device from the physical space; acquiring the first point cloud data by performing point cloud segmentation on the raw point cloud data.

In some embodiments, the method further includes: associating a plurality of frames of the second point cloud data.

In some embodiments, wherein the point cloud completion network is acquired based on the following: training an initial point cloud completion network based on sample complete point cloud data; acquiring the third point cloud data which is generated by the trained point cloud completion network based on the target latent space vector; acquiring the point cloud completion network by optimizing the trained point cloud completion network based on the real point cloud data and the fourth point cloud data.

In some embodiments, the method further includes: acquiring a plurality of point cloud blocks in the third point cloud data; for each of the plurality of point cloud blocks, determining a points-distribution feature of the point cloud block; establishing a loss function based on respective points-distribution features of the plurality of point cloud blocks; optimizing the trained point cloud completion network based on the loss function.

In some embodiments, the method further includes: acquiring a plurality of initial latent space vectors sampled from a latent space; for each of the initial latent space vectors, determining a target function of the initial latent space vector based on the point cloud data corresponding to the initial latent space vector and the real point cloud data; determining the target latent space vector from the initial latent space vectors based on respective target functions of the initial latent space vectors.

In some embodiments, wherein the preset degradation includes: for each of a plurality of target points in the real point cloud data, determining one or more points nearest to the target point in the third point cloud data as neighbor points of the target point; taking a union of respective neighbor points of the plurality of target points in the real point cloud data as the fourth point cloud data acquired from the third point cloud data by performing preset degradation.

According to a second aspect of the embodiments of the present disclosure, a method of training a point cloud completion network is provided, including: training an initial point cloud completion network based on sample complete point cloud data; acquiring completed point cloud data which is generated by the trained point cloud completion network based on target latent space vector; optimizing the trained point cloud completion network based on real point cloud data collected from a physical space and degraded point cloud data acquired from the completed point cloud data by performing preset degradation, such that a difference between the degraded point cloud data and the real point cloud data is within a preset difference range.

In some embodiments, the method further includes: acquiring a plurality of initial latent space vectors sampled from a latent space; for each of the initial latent space vectors, determining completed point cloud data which is generated by the trained point cloud completion network based on the initial latent space vector, and acquiring degraded point cloud data by performing preset degradation on the completed point cloud data; determining a target function corresponding to the initial latent space vector based on the degraded point cloud data corresponding to the initial latent space vector and the real point cloud data; determining the target latent space vector from the initial latent space vectors based on respective target functions of the initial latent space vectors.

In some embodiments, the preset degradation includes: for each of a plurality of target points in the real point cloud data, determining one or more points nearest to the target point in sample complete point cloud data as neighbor points of the target point; taking a union of respective neighbor points of the plurality of target points in the real point cloud data as degraded point cloud data acquired from the sample complete point cloud data by performing preset degradation.

According to a third aspect of the embodiments of the present disclosure, a method of processing point cloud data is provided, including: acquiring first to-be-processed point cloud data and second to-be-processed point cloud data in a game area, wherein the first to-be-processed point cloud data corresponds to a game participant and the second to-be-processed point cloud data corresponds to a game object; acquiring first processed point cloud data by completing the first to-be-processed point cloud data with a point cloud completion network and acquiring second processed point cloud data by completing the second to-be-processed point cloud data with the point cloud completion network; associating the first processed point cloud data and the second processed point cloud data; wherein, the point cloud completion network is trained based on complete point cloud data and configured to generate completed point cloud data according to target latent space vector, and a difference between real point cloud data collected from a physical space and degraded point cloud data acquired from the completed point cloud data by performing preset degradation is within a preset difference range.

In some embodiments, wherein the game object comprises a game coin placed into the game area, and the method further includes, based on the association of the first processed point cloud data and the second processed point cloud data, determining one or more game coins placed by the game participant in the game area.

In some embodiments, the method further includes: based on the association of the first processed point cloud data and the second processed point cloud data, determining an action performed by the game participant on the game object.

In some embodiments, acquiring the first to-be-processed point cloud data and the second to-be-processed point cloud data in the game area includes: acquiring raw point cloud data collected by a point cloud collecting device set around the game area; acquiring the first to-be-processed point cloud data corresponding to the game participant and the second to-be-processed point cloud data corresponding to the game object by performing point cloud segmentation on the raw point cloud data.

In some embodiments, the point cloud completion network is configured to complete the first to-be-processed point cloud data corresponding to game participants of a plurality of categories and/or the second to-be-processed point cloud data corresponding to game objects of a plurality of categories; or the point cloud completion network includes a first point cloud completion network configured to complete the first to-be-processed point cloud data corresponding to a game participant of a first category, and a second point cloud completion network configured to complete the second to-be-processed point cloud data corresponding to a game object of a second category.

According to a fourth aspect of the embodiments of the present disclosure, a method of processing point cloud data is provided, including: acquiring to-be-processed point cloud data corresponding to a target object in a game area, wherein the target object comprises at least one of a game participant and a game object; acquiring processed point cloud data by completing the to-be-processed point cloud data with a point cloud completion network; identifying the target object based on the processed point cloud data, wherein, the point cloud completion network is trained based on complete point cloud data and configured to generate completed point cloud data according to target latent space vector, and a difference between real point cloud data collected from a physical space and degraded point cloud data acquired from the completed point cloud data by performing preset degradation is within a preset difference range.

In some embodiments, acquiring the to-be-processed point cloud data corresponding to the target object in the game area includes: acquiring raw point cloud data collected by a point cloud collecting device set around the game area; acquiring the to-be-processed point cloud data corresponding to target objects of a plurality of categories by performing point cloud segmentation on the raw point cloud data.

In some embodiments, the point cloud completion network is used for completing to-be-processed point cloud data corresponding to target objects of a plurality of categories; or the point cloud completion network is used for completing to-be-processed point cloud data corresponding to target objects of a specific category.

According to a fifth aspect of the embodiments of the present disclosure, an apparatus for completing point cloud data is provided, including: a first acquiring module, configured to acquire first point cloud data; a point cloud completion module, configured to acquire second point cloud data by completing the first point cloud data with a point cloud completion network; wherein, the point cloud completion network is trained based on complete point cloud data and configured to generate third point cloud data according to target latent space vector, and a difference between fourth point cloud data acquired from the third point cloud data by performing preset degradation and real point cloud data collected from a physical space is within a preset difference range.

In some embodiments, the apparatus further includes: an raw point cloud acquiring module, configured to acquire raw point cloud data collected by a point cloud collecting device from the physical space; and a point cloud segmentation module, configured to acquire the first to-be-processed point cloud data by performing point cloud segmentation on the raw point cloud data.

In some embodiments, the apparatus further includes: an associating module, configured to associate a plurality of frames of the second point cloud data.

In some embodiments, the apparatus further includes: a training module, configured to train an initial point cloud completion network based on sample complete point cloud data; and a third point cloud acquiring module, configured to acquire the third point cloud data which is generated by the trained point cloud completion network based on target latent space vector; and a first optimizing module, configured to obtain the point cloud completion network by optimizing the trained point cloud completion network based on the real point cloud data and the fourth point cloud data acquired from the third point cloud data by performing preset degradation.

In some embodiments, the apparatus further includes: a point cloud block acquiring module, configured to obtain a plurality of point cloud blocks in the third point cloud data; and a feature determining module, configured to for each of the plurality of point cloud blocks, determine a points-distribution feature of the point cloud block; and a loss function establishing module, configured to establish a loss function based on respective points-distribution features of the plurality of point cloud blocks; and a second optimizing module, configured to optimize the trained point cloud completion network based on the loss function.

In some embodiments, the apparatus further includes: a vector acquiring module, configured to acquire a plurality of initial latent space vectors sampled from a latent space; and a target function determining module, configured to for each of the initial latent space vectors, determining a target function of the initial latent space vector based on the point cloud data corresponding to the initial latent space vector and the real point cloud data; and a vector determining module, configured to determine the target latent space vector from the initial latent space vectors based on respective target functions of the initial latent space vectors.

In some embodiments, the preset degradation can be realized based on the following modules: an adjacent point determining module, configured to, for each of a plurality of target points in the real point cloud data, determine one or more points nearest to the target point in the third point cloud data as neighbor points of the target point; and a point cloud determining module, configured to take a union of respective neighbor points of the plurality of target points in the real point cloud data as the fourth point cloud data acquired from the third point cloud data by performing preset degradation.

According to a sixth aspect of the embodiments of the present disclosure, an apparatus for training a point cloud completion network is provided, including: a training module, configured to train an initial point cloud completion network based on sample complete point cloud data; and a second acquiring module, configured to acquire completed point cloud data which is generated by the trained point cloud completion network based on target latent space vector; and an optimizing module, configured to optimize the trained point cloud completion network based on real point cloud data collected from a physical space and degraded point cloud data acquired from the completed point cloud data by performing preset degradation, such that a difference between the degraded point cloud data and the real point cloud data is within a preset difference range.

In some embodiments, the apparatus further includes: a vector acquiring module, configured to acquire a plurality of initial latent space vectors sampled from a latent space; and a degraded point cloud acquiring module, configured to, for each of the initial latent space vectors, determine completed point cloud data which is generated by the trained point cloud completion network based on the initial latent space vector, and acquire degraded point cloud data by performing preset degradation on the completed point cloud data; and a target function determining module, configured to determine a target function corresponding to the initial latent space vector based on the degraded point cloud data corresponding to the initial latent space vector and the real point cloud data; and a target latent space vector determining module, configured to determine the target latent space vector from the initial latent space vectors based on the respective target function of each initial latent space vectors.

In some embodiments, the apparatus further includes: for each of a plurality of target points in the real point cloud data, determining one or more points nearest to the target point in sample complete point cloud data as neighbor points of the target point; determining a union of respective neighbor points of the plurality of target points in the real point cloud data as degraded point cloud data acquired from the sample complete point cloud data by performing preset degradation.

According to a seventh aspect of the embodiments of the present disclosure, an apparatus for processing point cloud data is provided, including: a third acquiring module, configured to acquire first to-be-processed point cloud data and second to-be-processed point cloud data in a game area, wherein the first to-be-processed point cloud data corresponds to a game participant and the second to-be-processed point cloud data corresponds to a game object; and an inputting module, configured to acquire first processed point cloud data by completing the first to-be-processed point cloud data with a point cloud completion network and acquire second processed point cloud data by completing the second to-be-processed point cloud data with the point cloud completion network; and an associating module, configured to associate the first processed point cloud data and the second processed point cloud data; wherein, the point cloud completion network is trained based on complete point cloud data and configured to generate completed point cloud data according to target latent space vector, and a difference between real point cloud data collected from a physical space and degraded point cloud data acquired from the completed point cloud data by performing preset degradation is within a preset difference range.

In some embodiments, the game object includes a game coin placed into the game area, and the apparatus further includes: an associating module, configured to, based on the association of the first processed point cloud data and the second processed point cloud data, determine one or more game coins placed by the game participant in the game area.

In some embodiments, the apparatus further includes: an action determining module, configured to, based on the association of the first processed point cloud data and the second processed point cloud data, determine an action performed by the game participant on the game object.

In some embodiments, the third acquiring module includes: an raw point cloud data acquiring unit, configured to obtain raw point cloud data collected by a point cloud collecting device set around the game area; and a point cloud segmentation unit, configured to obtain the first to-be-processed point cloud data corresponding to the game participant and the second to-be-processed point cloud data corresponding to the game object by performing point cloud segmentation on the raw point cloud data.

In some embodiments, the point cloud completion network is configured to complete the first to-be-processed point cloud data corresponding to game participants of a plurality of categories and/or the second to-be-processed point cloud data corresponding to game objects of a plurality of categories; or the point cloud completion network comprises a first point cloud completion network configured to complete the first to-be-processed point cloud data corresponding to a game participant of a first category, and a second point cloud completion network configured to complete the second to-be-processed point cloud data corresponding to a game object of a second category.

According to an eighth aspect of the embodiments of the present disclosure, an apparatus for processing point cloud data is provided, including: a fourth acquiring module, configured to acquire to-be-processed point cloud data corresponding to a target object in a game area, wherein the target object comprises at least one of a game participant and a game object; and a fifth acquiring module, configured to acquire processed point cloud data by completing the to-be-processed point cloud data with a point cloud completion network; and an identifying module, configured to identify the target object based on the processed point cloud data, wherein, the point cloud completion network is trained based on complete point cloud data and configured to generate completed point cloud data according to target latent space vector, and a difference between real point cloud data collected from a physical space and degraded point cloud data acquired from the completed point cloud data by performing preset degradation is within a preset difference range.

According to a ninth aspect of the embodiments of the present disclosure, a system for processing point cloud data is provided, including: a point cloud collecting device set around a game area, for collecting first to-be-processed point cloud data and second to-be-processed point cloud data in the game area, wherein the first to-be-processed point cloud data corresponds to a game participant and the second to-be-processed point cloud data corresponds to a game object; and a processing unit communicatively connected to the point cloud collecting device, for acquiring first processed point cloud data by completing the first to-be-processed point cloud data with a point cloud completion network and acquiring second processed point cloud data acquired by completing the second to-be-processed point cloud data with the point cloud completion network, and associating the first processed point cloud data and the second processed point cloud data; wherein, the point cloud completion network is trained based on complete point cloud data and configured to generate completed point cloud data according to target latent space vector, and a difference between real point cloud data collected from a physical space and degraded point cloud data acquired from the completed point cloud data by performing preset degradation is within a preset difference range.

According to a tenth aspect of the embodiments of the present disclosure, a system for processing point cloud data is provided, including: a point cloud collecting device set around a game area, for collecting to-be-processed point cloud data corresponding to a target object in the game area, wherein the target object includes at least one of a game participant and a game object; and a processing unit communicatively connected to the point cloud collecting device, for acquiring processed point cloud data by completing the to-be-processed point cloud data with a point cloud completion network, and identifying the target object based on the processed point cloud data; wherein, the point cloud completion network is trained based on complete point cloud data and configured to generate completed point cloud data according to target latent space vector, and a difference between real point cloud data collected from a physical space and degraded point cloud data acquired from the completed point cloud data by performing preset degradation is within a preset difference range.

According to a eleventh aspect of the embodiments of the present disclosure, a computer readable storage medium storing a computer program is provided, when the computer program is executed by a processor, the method according to any one of above embodiments is implemented.

According to a twelfth aspect of the embodiments of the present disclosure, a computer device is provided, including a memory, a processor and a computer program stored on the memory and executable on the processor, when the computer program is executed by a processor, the method according to any one of above embodiments is implemented.

In the embodiments of the present disclosure, the point cloud completion network can be trained by only using complete point cloud data as training data, without collecting a point cloud pair composed of complete point cloud data and incomplete point cloud data as training data. Meanwhile, a difference between fourth point cloud data acquired from third point cloud data generated by the trained point cloud completion network with performing preset degradation and real point cloud data collected from the physical space is within a preset difference range, thus, ensuring that the result output by the point cloud completion network is close to the real point cloud data. Therefore, solutions of the embodiments of the present disclosure can be applied to completion of various forms of incomplete point clouds with good generalization performance.

It should be understood that the above general description and the following detailed description are only exemplary and explanatory, rather than limiting the present disclosure.

### BRIEF DESCRIPTION OF THE DRAWINGS

The accompanying drawings, which are incorporated in and constitute a part of this specification, illustrate examples consistent with the present disclosure and, together with the description, serve to explain the technical solution of the disclosure.

FIG. 1(a), FIG. 1(b) and FIG. 1(c) are schematic diagrams illustrating incomplete point cloud data according to some embodiments.

FIG. 2 is a flowchart illustrating a method of completing point cloud data according to some embodiments of the present disclosure.

FIG. 3 is a schematic diagram illustrating training and optimizing the point cloud completion network according to some embodiments of the present disclosure.

FIG. 4 is a schematic diagram illustrating a points-distribution feature in the point cloud data according to some embodiments of the present disclosure..

FIG. 5 is a schematic diagram illustrating degradation according to some embodiments of the present disclosure.

FIG. 6 is a schematic diagram illustrating various candidate complete point cloud data output by the point cloud completion network.

FIG. 7 is a flowchart illustrating a method of training a point cloud completion network according to some embodiments of the present disclosure.

FIG. 8 is a flowchart illustrating a method of processing point cloud data according to an embodiment of the present disclosure.

FIG. 9 is a flowchart illustrating a method of processing point cloud data according to another embodiment of the present disclosure.

FIG. 10 is a block diagram illustrating an apparatus for completing point cloud data according to some embodiments of the present disclosure.

FIG. 11 is a block diagram illustrating an apparatus for training a point cloud completion network according to some embodiments of the present disclosure.

FIG. 12 is a block diagram illustrating an apparatus for processing point cloud data according to an embodiment of the present disclosure.

FIG. 13 is a block diagram illustrating an apparatus for processing point cloud data according to another embodiment of the present disclosure.

FIG. 14 is a schematic diagram illustrating a system for processing point cloud data according to some embodiments of the present disclosure.

FIG. 15 is a schematic structural diagram illustrating a computer device according to some embodiments of the present disclosure.

### DETAILED DESCRIPTION OF THE EMBODIMENTS

Examples will be described in detail herein, with the illustrations thereof represented in the drawings. When the following descriptions involve the drawings, like numerals in different drawings refer to like or similar elements unless otherwise indicated. The embodiments described in the following examples do not represent all embodiments consistent with the present disclosure. Rather, they are merely examples of apparatuses and methods consistent with some aspects of the present disclosure as detailed in the appended claims.

The terminology used in the present disclosure is for the purpose of describing particular embodiments only and is not intended to limit the present disclosure. The singular forms ‘a’, ‘said’ and ‘the’ used in the present disclosure and the appended claims are also intended to include the majority of forms unless the context clearly indicates other meanings. It should also be understood that the term ‘and/or’ as used herein refers to and includes any or all possible combinations of one or more associated listed items. In addition, the term ‘at least one’ herein means any combination of at least two of any one or more of a plurality.

In order to make those skilled in the art better understand the technical solutions in the embodiments of the present disclosure, and make the described objects, features and advantages of the embodiments of the present disclosure more apparent, the technical solutions in the embodiments of the present disclosure will be further described in detail below with reference to the accompanying drawings.

In practical applications, point cloud data is always required to be collected and performed with some processing. For example, in the field of autonomous driving, a LiDAR may be installed on autonomous vehicles, and the LiDAR may be used to collect point cloud data around the vehicle and analyze the point cloud data to determine moving speed of obstacles around the vehicle, so to perform a route planning for the vehicles effectively. For another example, in the field of robot navigation, point cloud data of the surrounding environment of the robot can be collected, and the robot can be positioned based on various objects identified from the point cloud data. For another example, in some game scenarios, point cloud data in a game area can be collected, and various targets (for example, game participants and game objects) identified from the point cloud data can be associated.

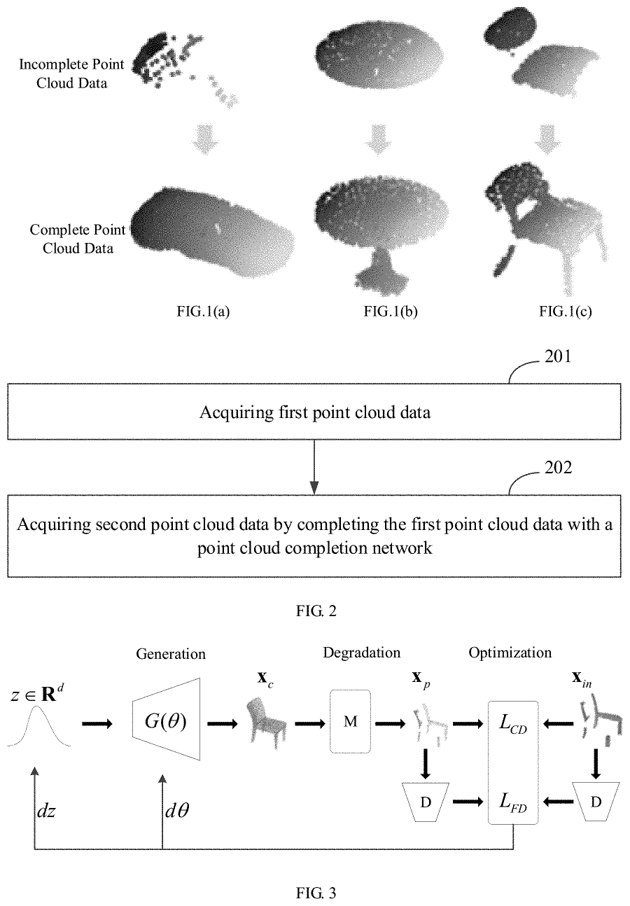

However, in actual scenarios, due to occlusion and other reasons, the collected 3D point cloud is always not complete point cloud data, but incomplete point cloud data. For example, for a 3D object, the surface facing away from the point cloud collecting device may be occluded by the surface facing the point cloud collecting device, resulting in the point cloud facing away from the point cloud collecting device cannot be collected. Even if it is a flat object, because there are always multiple overlapping objects in a scenario, the surface of one object may be occluded by the surface of another object, resulting in incompletion of the collected point cloud data. In addition, there are many other reasons for the generation of the incomplete point cloud, and the collected forms of the incomplete point cloud are also diverse. FIG. 1(a), FIG. 1(b) and FIG. 1(c) are schematic diagrams illustrating an incomplete cloud collected in a physical space and a corresponding complete point cloud according to some embodiments.

It should be noted that the incomplete cloud data in the present disclosure refers to point cloud data that cannot represent the complete shape of the object. For example, when an object includes one or more surfaces, a part of the surfaces or a partial area of one surface may be occluded, and the collected point cloud data does not include the points of the occluded surface or area, so that the collected point cloud data cannot represent the corresponding shape of the occluded surface or area. The surfaces face different directions, or there is a sudden change in direction between each other. Correspondingly, the complete point cloud data refers to point cloud data that can represent the complete shape of the object. For example, in a case where an object includes one or more surfaces, the point cloud data includes points on each surface, so that the point cloud data can completely represent the shape of each surface.

Operations based on the incomplete point cloud are difficult to achieve expected results. Therefore, it is necessary to perform point cloud completion on the incomplete point cloud data to obtain the complete point cloud data corresponding to the incomplete point cloud data. In related art, generally incomplete point cloud data is completed with a trained point cloud completion network, which is obtained by performing fully supervised training on a point cloud completion network with training data composed of paired incomplete point cloud data and complete point cloud data. However, the forms of incomplete cloud data are often varied due to the types of sensors or occlusions, and the incomplete point cloud data in the training set is generally artificially generated based on a certain strategy, the form of which is not as rich as that of the real incomplete point cloud data collected from physical space. Therefore, the point cloud completion network obtained based on the above method is difficult to generalize to other forms of incomplete point cloud data, and the generalization performance is poor.

Based on this, the present disclosure provides a method of completing point cloud data. As shown in FIG. 2, the method includes:

At step 201, first point cloud data is acquired.

At step 202, second point cloud data is acquired by completing the first point cloud data with a point cloud completion network.

Wherein, the point cloud completion network is trained based on complete point cloud data and configured to generate third point cloud data according to target latent space vector, and a difference between fourth point cloud data acquired from the third point cloud data by performing preset degradation and real point cloud data collected from a physical space is within a preset difference range.

In step 201, the first point cloud data indicates partial point cloud data, and the first point cloud data may be acquired from a point cloud collecting device configured to collect point cloud data.

In step 202, the second point cloud data may be obtained by inputting the first point cloud data into a point cloud completion network, so as to complete the first point cloud data with the point cloud completion network, where the second point cloud data indicates complete point cloud data. The first point cloud data collected by the point cloud collecting device can be directly input into the point cloud completion network for completion processing, or can be preprocessed first, and then the preprocessed first point cloud data can be input into the point cloud completion network for completion processing. The preprocessing may include, for example, filtering processing, which is used to filter out obviously wrong points from the first point cloud data. The preprocessing may further include performing point cloud segmentation on raw point cloud data collected by the point cloud collecting device from the physical space to obtain the first point cloud data.

The point cloud completion network in this step, for example, may be obtained based on any kind of Generative Adversarial Networks (GAN) including but not limited to tree-GAN or r-GAN. That is, the point cloud completion network can be used as a generator to be obtained through confrontation training with a preset discriminator. The point cloud completion network can be trained by only using complete point cloud data as training data, without collecting a point cloud pair composed of complete point cloud data and incomplete cloud data as training data. Since it is difficult to collect complete point cloud data in real scenarios, the complete point cloud data used as training data in the present disclosure may be artificially generated, for example, the complete point cloud data may be from a sample data set such as ShapeNet. Through training, the point cloud completion network can learn better prior information of spatial geometry based on the complete point cloud data. After training, the network parameters of the point cloud completion network can be further optimized, so that the optimized point cloud completion network can generate the third point could data according to the target latent space vector, and a difference between the real point cloud data collected from the physical space and fourth point cloud data acquired from the third point cloud data by performing degradation is within the preset difference range, therefore the point cloud completion network can be obtained in an unsupervised manner. The optimized point cloud completion network can be used to perform point cloud completion on the first point cloud data.

In practice, an optimization target can be set as that the difference between the real point cloud data collected from the physical space and fourth point cloud data acquired from the third point cloud data by performing preset degradation is within the preset difference range, and parameters of the point cloud completion network can be adjusted by setting corresponding optimization function, so as to achieve optimization of the point cloud completion network.

In the method of the embodiment of the present disclosure, a point cloud pair composed of complete point cloud data and incomplete point cloud data is not used. Since entire training process does not involve incomplete point cloud data, the point cloud completion network can be applied to complete various forms of incomplete point cloud data, such that generalization performance of which is high, and the point cloud completion network has a good robustness to point clouds with different degrees of incompleteness; and, since the point cloud completion network is optimized, which ensuring that the difference between the real point cloud data collected from the physical space and fourth point cloud data acquired the third point cloud data by performing preset degradation is relatively small, the result of point cloud completion can be relatively accurate.

In some embodiments, the point cloud completion network may be acquired in the following manner: training an initial point cloud completion network based on sample complete point cloud data; acquiring the third point cloud data which is generated by the trained point cloud completion network based on target latent space vector; optimizing the trained point cloud completion network based on the real point cloud data and fourth point cloud data obtained from the third point cloud data by performing preset degradation, to obtain the point cloud completion network. The point cloud completion network obtained by the above method does not use incomplete point cloud data as training data in the training process, and can be applied to completion for various forms of incomplete point cloud data, the generalization performance of which is relatively good.

An optimal initial latent space vector can be selected from a plurality of initial latent space vectors as target latent space vector. The plurality of initial latent space vectors may be acquired by sampling from a latent space, and the sampling method may be random sampling. In some embodiments, the latent space may be a 96-dimensional space, and a 96-dimensional vector can be randomly generated for each sampling, that is, the initial latent space vector. For each of the initial latent space vectors, the point cloud data generated by an initial point cloud completion network based on the initial latent space vector can be acquired, target function of the initial latent space vector can be determined based on point cloud data corresponding to the initial latent space vector and the real point cloud data. Then, based on respective target functions of the initial latent space vector, the target latent space vector is determined from the initial latent space vectors.

The distance between the point cloud data corresponding to the initial latent space vector and the real point cloud data may be used as the target function. In some embodiments, a chamfer distance and a feature distance between the fourth point cloud data and the real point cloud data can be determined, and a sum of the chamfer distance and the feature distance is determined as the target function. The chamfer distance and the feature distance are as follows:

$${L}_{C D} ( {x}_{p} , {x}_{in} ) = \frac{1}{\vert {x}_{p} \vert} {\sum }_{p ∈ {x}_{p}} {min}_{q ∈ {x}_{in}} {‖ p - q ‖}_{2}^{2} + \frac{1}{\vert {x}_{in} \vert} {\sum }_{q ∈ {x}_{in}} {min}_{p ∈ {x}_{p}} {‖ p - q ‖}_{2}^{2} ;$$

$${L}_{F D} = {‖ D ( {x}_{p} ) - D ( {x}_{in} ) ‖}_{1} .$$

where L_{CD} and L_{FD} represents the chamfer distance and the feature distance respectively, and xₚ represents the fourth point cloud data acquired from the third point cloud data by performing preset degradation, xᵢₙ represents the real point cloud data, p and q represents points in xₚ and points in xᵢₙ respectively, ∥·∥₁ and ∥·∥₂ represents norm 1 and norm 2 respectively D(xₚ) and D(xₘ) represents the feature vector of ^{x}ₚ and xᵢₙ respectively. The above is only an example of the target function. In addition to the target function described above, other types of target function can also be used according to actual requirements, which will not be repeated here.

After acquiring a target function corresponding to each initial latent space vector, the initial latent space vector with the smallest target function may be determined as the target latent space vector. Then, the target function corresponding to the target latent space vector is acquired, and the network parameters of the point cloud completion network are optimized based on the target function corresponding to the target latent space vector. The optimization method includes, but is not limited to, the gradient descent method. In the optimization, the target latent space vector and the network parameters of the point cloud completion network can be optimized at the same time to minimize the target function corresponding to the target latent space vector.

Training and optimizing the point cloud completion network is shown in FIG. 3, a generator in a generative confrontation network is used as the point cloud completion network. The generative confrontation network includes a generator G and a discriminator D. The two D shown in the figure can be the same discriminator. The feature distance can be calculated based on the features output by an intermediate layer of the discriminator D in the trained generative confrontation network. In a training stage, a plurality of initial latent space vectors are collected randomly from the latent space R^{d} and input to generator G to obtain the complete point cloud data corresponding to each initial latent space vector, that is, the third point cloud data x_{c}, and the x_{c} is degraded to incomplete point cloud data xₚ, based on the incomplete point cloud data xₚ and the real point cloud data xᵢₙ sampled in the physical space, the target function is acquired, so that the optimal target latent space vector z is acquired. Using the gradient descent method to optimize the target latent space vector z and the parameter θ of the generator, the target function corresponding to the target latent space vector can be minimized, so as to obtain optimized point cloud completion network.

In the embodiments of the present disclosure, based on the above methods, the optimal target latent space vector can be selected from a plurality of initial latent space vectors to optimize the point cloud completion network, the selecting of which can accelerate optimization speed of the point cloud completion network and improve efficiency of optimization.

In some embodiments, the third point cloud data may be degraded in the following manners: for each of a plurality target points in the real point cloud data, determining one or more points adjacent to the target point in the third point cloud data as neighbor points of the target point; determining a union of respective neighbor points of the plurality of target points in the real point cloud data as fourth point cloud data acquired from the third point cloud data by performing preset degradation.

As shown in FIG. 5, for a point P1 in the real point cloud data xᵢₙ, neighbor points of P1 in the third point cloud data x_{c} may be acquired, the neighbor points may include k points nearest to P1 in x_{c}, which are the points shown in area S1. In the same way, neighbor points in the third point cloud data x_{c} of a point P2 in the real point cloud data xᵢₙ can be acquired, which are the points shown in area S2. In the same way, neighbor points in the third point cloud data x_{c} of other target points in the real point cloud data xᵢₙ can be acquired, the target points may include some of all of the points in the real point cloud data xᵢₙ, for example, the target points may be the points uniformly sampled according to a preset sampling rate from the real point cloud data xᵢₙ. Optionally, the preset sampling rate may be lower than 1/k, so that the number of points in the degraded point cloud data will be reduced. Since the neighbor points of each target point may partially overlap, a union of respective neighbor points of the plurality of target points can be taken as fourth point cloud data acquired from the third point cloud data by performing degradation.

In some embodiments, the distribution of points in the point cloud data is not even, that is, the distribution of points in the point cloud data is dense in some areas, and scattered in other areas. FIG. 4 is a comparison diagram of evenly distributed point cloud data a and unevenly distributed point cloud data b. It can be seen that in point cloud data b, most of the collected points are distributed in the dotted box, while the distribution of points in other regions is more scattered. Since the number of points that the point cloud completion network can handle is relatively fixed, the unevenness of the point cloud data means that the number of points in some areas may not be enough for the point cloud completion network to obtain enough information for point cloud completion, which causes the inaccuracy of the result of point cloud completion. Therefore, in order to solve the above problem, in training and optimizing the point cloud completion network, the network parameters of the point cloud completion network can also be optimized, so that the distribution of points in the point cloud data acquired by the point cloud completion network performing the point cloud completion is more even.

In training and optimizing stage of the point cloud completion network, point cloud data C output by the point cloud completion network based on the latent vector can be acquired, and the points-distribution feature in the point cloud data C can be acquired. A loss function is established based on the points-distribution feature in the point cloud data C, and the point cloud completion network is optimized based on the loss function.

N seed positions can be randomly sampled from the point cloud data C. For example, the sampling method may be the farthest point sampling (FPS), so that the distance between each seed position is the farthest. The points-distribution feature in a point cloud block may be determined based on the average distance between each point in the point cloud block and a certain position (for example, a seed position) in the point cloud block. The loss function can be written as:

$${L}_{patch} = Var ( {\{ {ρ}_{j} \}}_{j = 1}^{n} ) , {ρ}_{j} = \frac{1}{k} {\sum }_{i = 1}^{k} d i s {t}_{ij}^{2} .$$

where L_{patch} is the loss function, Var represents the variance, ρⱼ is the average distance of the points in the j-th point cloud block, n is the total number of point cloud blocks, k is the total number of points in the point cloud block, distᵢⱼ is the distance between the i-th point in the j-th point cloud block and the seed position. The network parameters of the point cloud completion network can be adjusted to minimize the variance of the average distance corresponding to each point cloud block in the point cloud data C output by the point cloud completion network. In this way, the distance between different points in each point cloud block and the seed point can be closer, thereby improving the evenness of the point cloud data output by the point cloud completion network.

The network optimization based on the above loss function can be performed synchronously with the network optimization based on the target function obtained with the fourth point cloud data and the real point cloud data, or can be performed in any order, which is not limited in the present disclosure.

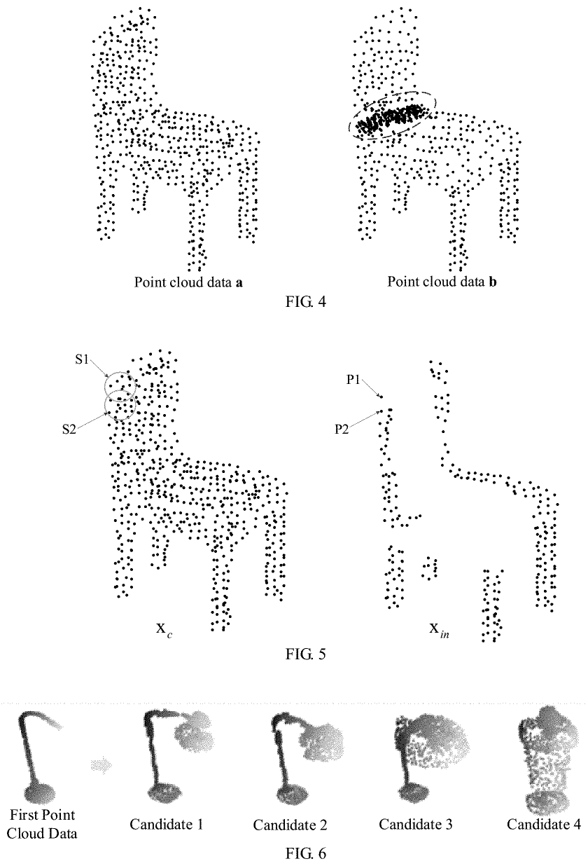

For each input first point cloud data, the point cloud completion network can output one or more candidate complete point cloud data. FIG. 6 is a schematic diagram of first point cloud data of a lamp and corresponding candidate complete point cloud data of some embodiments. Based on the first point cloud data, the point cloud completion network has output a total of 4 candidate complete point cloud data for selection. Further, a selection instruction for each candidate complete point cloud data can be acquired, and in response to the selection instruction, one of the candidate complete point cloud data is selected as the second point cloud data.

The present disclosure can be used in any scene equipped with a 3D sensor (such as a depth camera or a LiDAR), and the incomplete point cloud data of the entire scene can be scanned by the 3D sensor. The incomplete point cloud data of each object in the scene generates complete point cloud data through the second point cloud completion network, and then a 3D reconstruction of the entire scene can be performed. The reconstructed scene can provide accurate spatial information, such as detecting the distance between a human body and other objects in the scene, and the distance between people. The spatial information can be used to associate people with objects, and associate people with people, so as to improve the accuracy of the association.

In some embodiments, multiple frames of second point cloud data can be acquired, and multiple frames of second point cloud data can be associated. The multiple frames of second point cloud data may be second point cloud data of objects of the same category. For example, in a game scene, each frame of second point cloud data may be point cloud data corresponding to a game participant. By associating the point cloud data corresponding to multiple game participants, each game participant participating in a same game in a same game area can be determined. The multiple frames of second point cloud data may also be second point cloud data of objects of different categories. Still taking a game scene as an example, the multiple frames of second point cloud data may include point cloud data corresponding to game participants and point cloud data corresponding to the game objects. By associating the point cloud data corresponding to a game participant with the point cloud data corresponding to a game object, the relationship between the game participant and the game object can be determined, for example, game coins, game cards, cash belonging to the game participant; the game area where the game participant is located; and the seat where the game participant sits, etc.

The position and state of game participants and game objects in the game scene may change in real time. The relationship between game participants, the relationship between game participants and game objects may also change in real time, and these real-time changing information is of great significance for the analysis of the game state and the monitoring of the game progress. The incomplete point cloud data of game participants and/or game objects collected by the point cloud collecting device is completed, which is beneficial to improve the accuracy of association between the point cloud data and further improve the reliability of the result of game state analysis and game progress monitoring based on the association.

In some embodiments, after the second point cloud data is acquired, an object included in the second point cloud data may be identified, so as to determine the category of the object. The association process can also be performed on the multiple frames of second point cloud data based on the identification result. Further, in order to improve the accuracy of the association process and/or object identification, the second point cloud data may be homogenized before the association process and/or object identification are performed.

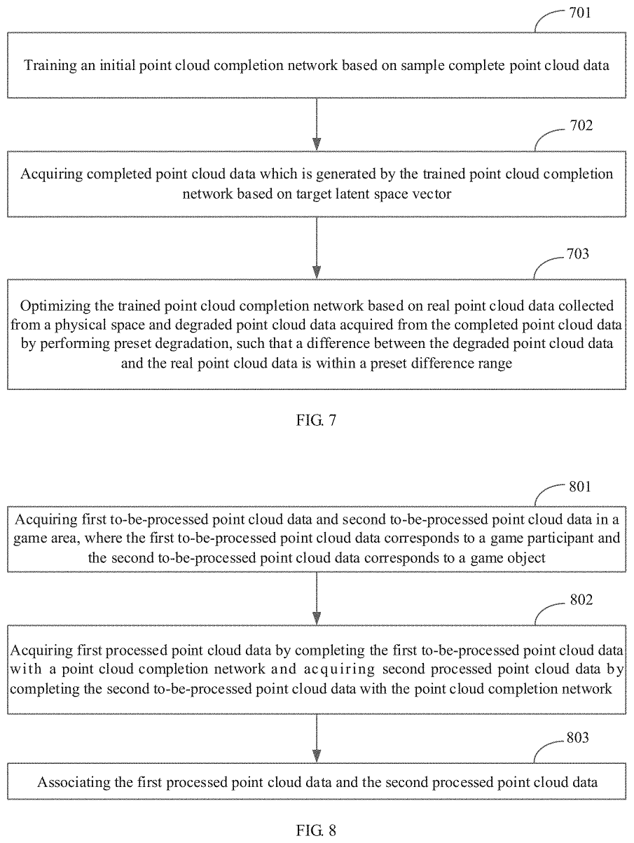

In some embodiments, as shown in FIG. 7, a method of training a point cloud completion network is also provided. The method includes:

At step 701, an initial point cloud completion network is trained based on sample complete point cloud data.

At step 702, completed point cloud data generated by the trained point cloud completion network based on target latent space vector is acquired.

At step 703, the trained point cloud completion network is optimized based on real point cloud data collected from a physical space and degraded point cloud data acquired from the completed point cloud data by performing preset degradation, such that a difference between the degraded point cloud data and the real point cloud data is within a preset difference range.

In some embodiments, the method further includes: acquiring a plurality of initial latent space vectors sampled from a latent space; for each of the initial latent space vectors, determining completed point cloud data which is generated by the trained point cloud completion network based on the initial latent space vector, and acquiring degraded point cloud data by performing preset degradation on the completed point cloud data; determining a target function corresponding to the initial latent space vector based on the degraded point cloud data corresponding to the initial latent space vector and the real point cloud data; determining the target latent space vector from the initial latent space vectors based on respective target functions of the initial latent space vectors.

In some embodiments, the preset degradation includes: for each of a plurality of target points in the real point cloud data, determining one or more points nearest to the target point in sample complete point cloud data as neighbor points of the target point; determining a union of respective neighbor points of the plurality of target points in the real point cloud data as degraded point cloud data acquired from the sample complete point cloud data by performing preset degradation.

The point cloud completion network trained with the method disclosed in this embodiment can be used in the method of completing point cloud data according to embodiments of the present disclosure to perform point cloud completion on the first point cloud data. For details involved in the training process, please refer to the embodiment of the method of completing the point cloud data, which will not be repeated here.

As shown in FIG. 8, the present disclosure also provides a method of processing point cloud data, including:

At step 801, first to-be-processed point cloud data and second to-be-processed point cloud data in a game area are acquired, wherein the first to-be-processed point cloud data corresponds to a game participant and the second to-be-processed point cloud data corresponds to a game object.

At step 802, first processed point cloud data is acquired by completing the first to-be-processed point cloud data with a point cloud completion network and second processed point cloud data is acquired by completing the second to-be-processed point cloud data with the point cloud completion network.

At step 803, the first processed point cloud data and the second processed point cloud data is associated.

Wherein, the point cloud completion network is trained based on complete point cloud data and configured to generate completed point cloud data according to target latent space vector, and a difference between real point cloud data collected from a physical space and degraded point cloud data acquired from the completed point cloud data by performing preset degradation is within a preset difference range.

The game participants may include, but is not limited to, at least one of a game referee, a game player, and a game audience.

In some embodiments, the game object includes a game coin placed into the game area; the method further includes: determining one or more game coins placed by the game participant in the game area based on the association of the first processed point cloud data and the second processed point cloud data. Each game participant can have a certain number of game coins for playing the game. By associating the game participant with the game coins, the number of game coins that the game participant placed into the game can be determined, the number of game coins that the game participants have and placed into different stages of the game, and whether the operations in the game process comply with the pre-set rules of the game can be determined, or pay out based on the amount of game coins placed and the result of the game at the end of the game.

In some embodiments, the method further includes: determining an action performed by the game participant on the game object based on the association of the first processed point cloud data and the second processed point cloud data. The action may include sitting, placing coins, dealing cards, and so on.

In some embodiments, acquiring the first to-be-processed point cloud data and the second to-be-processed point cloud data in the game area includes: acquiring raw point cloud data collected by a point cloud collecting device set around the game area; acquiring the first to-be-processed point cloud data corresponding to the game participant and the second to-be-processed point cloud data corresponding to the game object by performing point cloud segmentation on the raw point cloud data.

In some embodiments, the point cloud completion network is configured to complete the first to-be-processed point cloud data corresponding to game participants of a plurality of categories and/or the second to-be-processed point cloud data corresponding to game objects of a plurality of categories. In this case, a plurality of categories of the complete point cloud data can be used to train the point cloud completion network, and a plurality of categories of real point cloud data can be used to optimize the trained point cloud completion network in a network optimization stage.

Alternatively, the point cloud completion network includes a first point cloud completion network configured to complete the first to-be-processed point cloud data corresponding to a game participant of a first category, and a second point cloud completion network configured to complete the second to-be-processed point cloud data corresponding to a game object of a second category. In this case, different categories of complete point cloud data can be used to train different point cloud completion networks, and each trained point cloud completion network is optimized based on the point cloud data of corresponding category.

The point cloud completion network used in the embodiments of the present disclosure can be acquired with the foregoing method of training a point cloud completion network. The point cloud completion network completes the first to-be-processed point cloud data and the second to-be-processed point cloud data in the same way as that for completing the first point cloud data in aforementioned embodiment of method of completing point cloud data. For details, please refer to the foregoing embodiment of the method of completing point cloud data, which will not be repeated here.

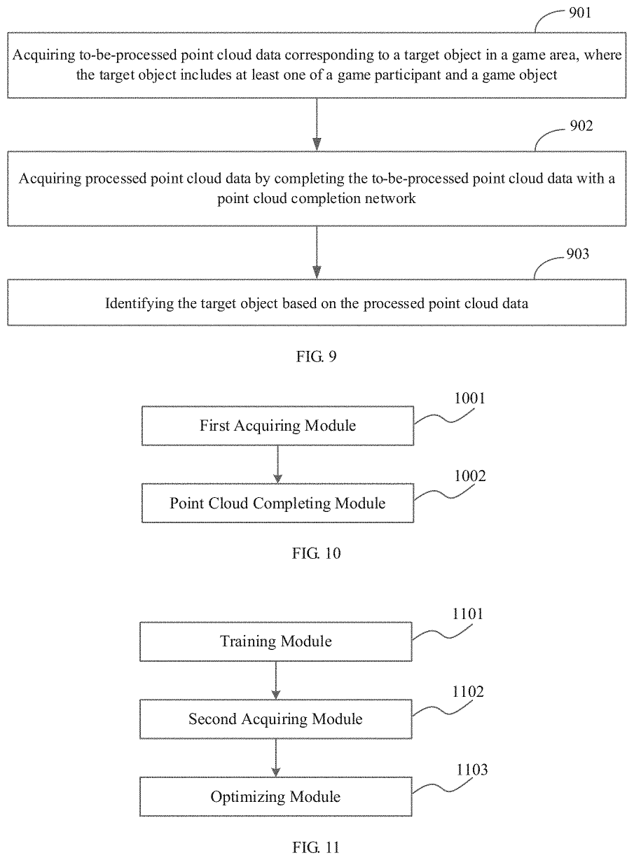

In some embodiments, as shown in FIG. 9, the present disclosure also provides a method of processing point cloud data, including:

At step 901, to-be-processed point cloud data corresponding to a target object in a game area is acquired, wherein the target object includes at least one of a game participant and a game object.

At step 902, processed point cloud data is acquired by completing the to-be-processed point cloud data with a point cloud completion network.

At step 903, the target object is identified based on the processed point cloud data.

Wherein, the point cloud completion network is trained based on complete point cloud data and configured to generate completed point cloud data according to target latent space vector, and a difference between real point cloud data collected from a physical space and degraded point cloud data acquired from the completed point cloud data by performing preset degradation is within a preset difference range.

In some embodiments, acquiring the to-be-processed point cloud data corresponding to the target object in the game area includes: acquiring raw point cloud data collected by a point cloud collecting device set around the game area; acquiring the to-be-processed point cloud data corresponding to target objects of a plurality of categories by performing point cloud segmentation on the raw point cloud data.

In some embodiments, the point cloud completion network is used for completing to-be-processed point cloud data corresponding to target objects of a plurality of categories; or the point cloud completion network is used for completing to-be-processed point cloud data corresponding to target objects of a specific category.

The point cloud completion network used in the embodiments of the present disclosure can be acquired with the foregoing method of training a point cloud completion network. The point cloud completion network completes the to-be-processed point cloud data in the same way as that for completing the first point cloud data in aforementioned embodiment of method of completing point cloud data. For details, please refer to the foregoing embodiment of the method of completing point cloud data, which will not be repeated here.

A person skilled in the art may understand that, in the described method of the specific implementation, the drafting order of each step does not imply that the strictly executed order forms any limitation to the implementation process, and the specific execution order of each step should be determined by its function and possibly intrinsic logic.

As shown in FIG. 10, the present disclosure also provides an apparatus for completing point cloud data, including: a first acquiring module 1001, configured to acquire first point cloud data; a point cloud completing module 1002, configured to acquire second point cloud data by completing the first point cloud data with a point cloud completion network; wherein, the point cloud completion network is trained based on complete point cloud data and configured to generate third point cloud data according to target latent space vector, and a difference between fourth point cloud data acquired from the third point cloud data by performing preset degradation and real point cloud data collected from a physical space is within a preset difference range.

In some embodiments, the apparatus further includes: an raw point cloud acquiring module, configured to acquire raw point cloud data collected by a point cloud collecting device from the physical space; and a point cloud segmentation module, configured to acquire the first to-be-processed point cloud data by performing point cloud segmentation on the raw point cloud data.

In some embodiments, the apparatus further includes: an associating module, configured to associate a plurality of frames of the second point cloud data.

In some embodiments, the apparatus further includes: a training module, configured to train an initial point cloud completion network based on sample complete point cloud data; and a third point cloud acquiring module, configured to acquire third point cloud data which is generated by the trained point cloud completion network based on target latent space vector; and a first optimizing module, configured to obtain the point cloud completion network by optimizing the trained point cloud completion network based on the real point cloud data and fourth point cloud data acquired from the third point cloud data by performing preset degradation.

In some embodiments, the apparatus further includes: a point cloud block acquiring module, configured to obtain a plurality of point cloud blocks in the third point cloud data; and a feature determining module, configured to for each of the plurality of point cloud blocks, determine a points-distribution feature of the point cloud block; and a loss function establishing module, configured to establish a loss function based on respective points-distribution feature of the plurality of point cloud blocks; and a second optimizing module, configured to optimize the trained point cloud completion network based on the loss function.

In some embodiments, the apparatus further includes: a vector acquiring module, configured to acquire a plurality of initial latent space vectors sampled from a latent space; and a target function determining module, configured to for each of the initial latent space vectors, determining a target function of the initial latent space vector based on the point cloud data corresponding to the initial latent space vector and the real point cloud data; and a vector determining module, configured to determine the target latent space vector from the initial latent space vectors based on respective target functions of the initial latent space vectors.

In some embodiments, the preset degradation can be realized based on the following modules: an adjacent point determining module, configured to, for each of a plurality of target points in the real point cloud data, determine one or more points nearest to the target point in the third point cloud data as neighbor points of the target point; and a point cloud determining module, configured to take a union of respective neighbor points of the plurality of target points in the real point cloud data as the fourth point cloud data acquired from the third point cloud data by performing preset degradation.

As shown in FIG. 11, the present disclosure also provides an apparatus for training point cloud completion network, including: a training module 1101, configured to train an initial point cloud completion network based on sample complete point cloud data; and a second acquiring module 1102, configured to acquire completed point cloud data which is generated by the trained point cloud completion network based on target latent space vector; and an optimizing module 1103, configured to optimize the trained point cloud completion network based on real point cloud data collected from a physical space and degraded point cloud data acquired from the completed point cloud data by performing preset degradation, such that a difference between the degraded point cloud data and the real point cloud data is within a preset difference range.

In some embodiments, the apparatus further includes: a vector acquiring module, configured to acquire a plurality of initial latent space vectors sampled from a latent space; and a degraded point cloud acquiring module, configured to, for each of the initial latent space vectors, determine completed point cloud data which is generated by the trained point cloud completion network based on the initial latent space vector, and acquire degraded point cloud data by performing preset degradation on the completed point cloud data; and a target function determining module, configured to determine a target function corresponding to the initial latent space vector based on the degraded point cloud data corresponding to the initial latent space vector and the real point cloud data; and a target latent space vector determining module, configured to determine the target latent space vector from the initial latent space vectors based on the respective target function of each initial latent space vectors.

In some embodiments, the apparatus further includes: for each of a plurality of target points in the real point cloud data, determining one or more neighbor points nearest to the target point in sample complete point cloud data as neighbor points of the target point; determining a union of respective neighbor points of the plurality of target points in the real point cloud data as degraded point cloud data acquired from the sample complete point cloud data by performing preset degradation.

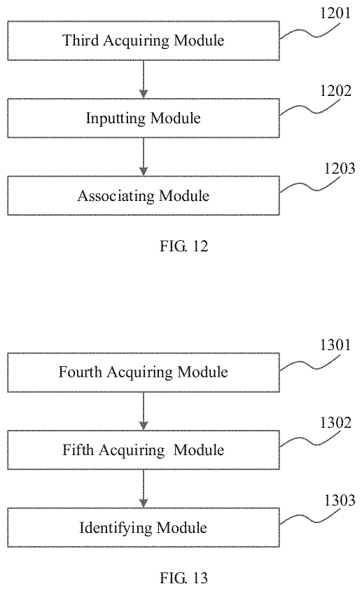

As shown in FIG. 12, the present disclosure also provides an apparatus for processing point cloud data, including: a third acquiring module 1201, configured to acquire first to-be-processed point cloud data and second to-be-processed point cloud data in a game area, wherein the first to-be-processed point cloud data corresponds to a game participant and the second to-be-processed point cloud data corresponds to a game object; an inputting module 1202, configured to acquire first processed point cloud data by completing the first to-be-processed point cloud data with a point cloud completion network and acquire second processed point cloud data by completing the second to-be-processed point cloud data with the point cloud completion network; an associating module 1203, configured to associate the first processed point cloud data and the second processed point cloud data; wherein, the point cloud completion network is trained based on complete point cloud data and configured to generate completed point cloud data according to target latent space vector, and a difference between real point cloud data collected from a physical space and degraded point cloud data acquired from the completed point cloud data by performing preset degradation is within a preset difference range.

In some embodiments, the game object includes a game coin placed into the game area, and the apparatus further includes: an associating module, configured to, based on the association of the first processed point cloud data and the second processed point cloud data, determine one or more game coins placed by the game participant in the game area.

In some embodiments, the apparatus further includes: an action determining module, configured to, based on the association of the first processed point cloud data and the second processed point cloud data, determine an action performed by the game participant on the game object.

In some embodiments, the third acquiring module includes: an raw point cloud data acquiring unit, configured to obtain raw point cloud data collected by a point cloud collecting device set around the game area; and a point cloud segmentation unit, configured to obtain the first to-be-processed point cloud data corresponding to the game participant and the second to-be-processed point cloud data corresponding to the game object by performing point cloud segmentation on the raw point cloud data.

In some embodiments, the point cloud completion network is configured to complete the first to-be-processed point cloud data corresponding to game participants of a plurality of categories and/or the second to-be-processed point cloud data corresponding to game objects of a plurality of categories; or the point cloud completion network comprises a first point cloud completion network configured to complete the first to-be-processed point cloud data corresponding to a game participant of a first category, and a second point cloud completion network is configured to complete the second to-be-processed point cloud data corresponding to a game object of a second category.

As shown in FIG. 13, the present disclosure also provides an apparatus for processing point cloud data, including: a fourth acquiring module 1301, configured to acquire to-be-processed point cloud data corresponding to a target object in a game area, wherein the target object comprises at least one of a game participant and a game object; a fifth acquiring module 1302, configured to acquire processed point cloud data by completing the to-be-processed point cloud data with a point cloud completion network; an identifying module 1303, configured to identify the target object based on the processed point cloud data, wherein, the point cloud completion network is trained based on complete point cloud data and configured to generate completed point cloud data according to target latent space vector, and a difference between real point cloud data collected from a physical space and degraded point cloud data acquired from the completed point cloud data by performing preset degradation is within a preset difference range.

In some embodiments, the functions or modules contained in the apparatuses provided in the embodiments of the present disclosure can be used to execute the methods described in the above method embodiments. For specific implementation, refer to the description of the above method embodiments, which will not be repeated here for brevity.

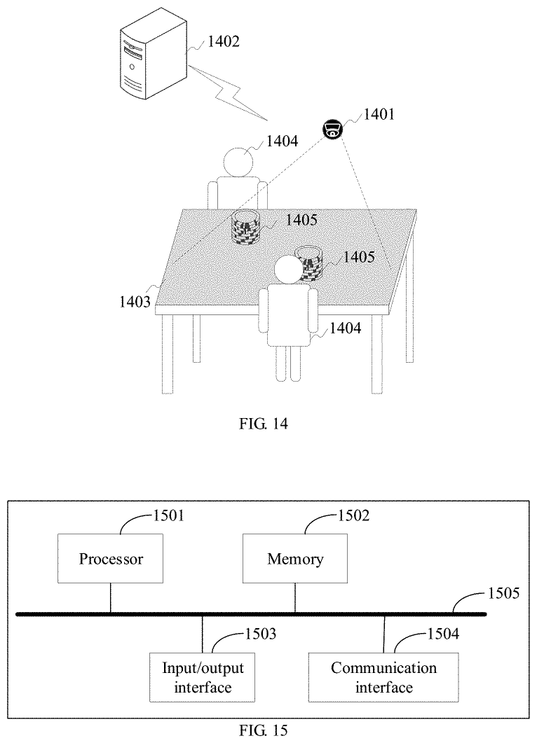

As shown in FIG. 14, the present disclosure also provides a system for processing point cloud data. The system includes a point cloud collecting device 1401 set around a game area 1403; and a processing unit 1402 communicatively connected to the point cloud collecting device 1401.

The point cloud collecting device 1401 can collect the first to-be-processed point cloud data of the game participant 1404 in the game area 1403 and the second to-be-processed point cloud data corresponding to the game object 1405, and the processing unit 1402 can obtain first processed point cloud data by completing the first to-be-processed point cloud data with a point cloud completion network and obtain second processed point cloud data by completing the second to-be-processed point cloud data with the point cloud completion network, and associate the first processed point cloud data and the second processed point cloud data.

The point cloud collecting device 1401 can collect the to-be-processed point cloud data of a target object in the game area; the target object includes at least one of a game participant and a game object. The processing unit 1402 can obtain the processed point cloud data by completing the to-be-processed point cloud data with the point cloud completion network, and identify the processed point cloud data.

Wherein, the point cloud completion network is trained based on complete point cloud data and configured to generate completed point cloud data according to target latent space vector, and a difference between real point cloud data collected from a physical space and degraded point cloud data acquired from the completed point cloud data by performing preset degradation is within a preset difference range.

In some embodiments, the point cloud collecting device 1401 may be a LiDAR or a depth camera. One or more point cloud collecting devices 1401 can be set around the game area. Different point cloud collecting devices 1401 can collect point cloud data of different sub-areas in the game area, and the sub-areas collected by different point cloud collecting devices 1401 can be overlapped.

The number of game participants in the game area may be one or more, and each game participant may correspond to one or more game objects, including but not limited to game coins, cash, seats, chess and cards, logo props and game table, etc. By identifying the target object based on the processed point cloud data, the categories of objects included in different point cloud data can be determined, and the spatial information where the objects of each category are located can also be determined. By associating the first processed point cloud data with the second processed point cloud data, the relationship between various game objects and game participants can be acquired, and the actions performed by the game participants can also be determined, and whether the operations in the game process comply with the pre-set rules of the game can be determined.

The embodiments of this specification also provide a computer device, which includes at least a memory, a processor, and a computer program stored on the memory and executable on the processor, when the computer program is executed by a processor, the method according to any of the above embodiments can be implemented.

FIG. 15 shows a more specific hardware structure diagram of a computing device provided by an embodiment of the present description, and the device may include a processor 1501, a memory 1502, an input/output interface 1503, a communication interface 1504, and a bus 1505. The processor 1501, the memory 1502, the input/output interface 1503, and the communication interface 1504 implement a communication connection between each other inside the device through the bus 1505.

The processor 1501 may be implemented by using a common central processing unit (CPU), a microprocessor, an Application specific integrated circuit (ASIC), or one or more integrated circuits, etc., for executing relevant programs to implement the technical solutions provided by the embodiments of the present description. The processor 1501 may also include a graphics card, and the graphics card may be an Nvidia titan X graphics card or a 1080Ti graphics card.

The memory 1502 may be implemented in the form of a read only memory (ROM), a random access memory (RAM), a static storage device, a dynamic storage device, and the like. The memory 1502 may store an operating system and other application programs. When the technical solutions provided in the embodiments of the present specification are implemented through software or firmware, related program codes are stored in the memory 1502 and are invoked and executed by the processor 1501.

The input/output interface 1503 is used to connect an input/output module to realize information input and output. The input/output/module can be configured in the device as a component (not shown in the figure), or it can be connected to the device to provide corresponding functions. The input device may include a keyboard, a mouse, a touch screen, a microphone, various sensors, etc., and an output device may include a display, a speaker, a vibrator, an indicator light, and the like.

The communication interface 1504 is used to connect a communication module (not shown in the figure) to implement communication interaction between the device and other devices. The communication module can realize communication through wired means (such as USB, network cable, etc.), or through wireless means (such as mobile network, WIFI, Bluetooth, etc.).

The bus 1505 includes a path to transmit information between various components of the device (for example, the processor 1501, the memory 1502, the input/output interface 1503, and the communication interface 1504).

It should be noted that although the above device only shows the processor 1501, the memory 1502, the input/output interface 1503, the communication interface 1504, and the bus 1505, in the specific implementation process, the device may also include other necessary components for normal operation. In addition, those skilled in the art can understand that the above-mentioned device may also include only the components necessary to implement the solutions of the embodiments of the present specification, and not necessarily include all the components shown in the figures.

Embodiments of the present disclosure further provides a computer readable storage medium having a computer program stored thereon, where the program is executed by a processor to perform steps in the method according to any of the embodiments as described above.

The computer readable medium includes permanent and non-permanent, removable and non-removable medium, and information storage can be realized by any method or technology. The information can be computer readable instructions, data structures, program modules, or other data. Examples of computer storage media include, but are not limited to, phase change memory (PRAM), static random access memory (SRAM), dynamic random access memory (DRAM), other types of random access memory (RAM), read-only memory (ROM), electrically erasable programmable read-only memory (EEPROM), flash memory or other memory technology, CD-ROM, digital versatile disc (DVD) or other optical storage, magnetic cassettes, magnetic tape storage or other magnetic storage devices or any other non-transmission media can be used to store information that can be accessed by computing devices. According to the definition in this article, the computer readable medium does not include transitory medium, such as modulated data signals and carrier waves.

From the description of the above implementation manners, it can be known that those skilled in the art can clearly understand that the embodiments of this specification can be implemented by means of software plus a necessary general hardware platform. Based on such understanding, the technical solutions of the embodiments of the present description essentially or the part contributing to the prior art may be embodied in the form of a software product. The computer software product may be stored in a storage medium. For example, a ROM/RAM, a magnetic disk, an optical disk, and the like include several instructions for enabling a computer device (which may be a personal computer. The server, or the network device, etc.) executes the method described in each embodiment or some part of the embodiment of the present description.

The systems, apparatuses, modules, or units explained in the above embodiments may be implemented by computer chips or entities, or implemented by products with certain functions. A typical implementation apparatus is a computer, and a specific form of the computer may be a personal computer, a laptop computer, a cellular phone, a camera phone, a smart phone, a personal digital assistant, a media player, a navigation device, an e-mail transceiver device, a game console, a tablet computer, a wearable device, or a combination of any of these devices.

Various embodiments in the present description are described in a progressive manner, and parts similar to each other may be referred to for each other, and the description of each embodiment is different from the other embodiments. Especially, for apparatus embodiments, since the apparatuses are basically similar to method embodiments, the description is simplified, and reference may be made to some of the description of the method embodiment. The apparatus embodiments described above are merely schematic, in which the modules described as separate components may or may not be physically separated, and the functions of the modules may be implemented in one or more software and/or hardware when the embodiments of the present description are implemented. Part or all of the modules a memory be selected according to actual requirements to implement the objectives of the solutions in the embodiments. Those of ordinary skill in the art can understand and implement without creative work.

1. A method of completing point cloud data, comprising:
acquiring first point cloud data;
acquiring second point cloud data by completing the first point cloud data with a point cloud completion network;
wherein, the point cloud completion network is trained based on complete point cloud data and configured to generate third point cloud data according to target latent space vector, and a difference between fourth point cloud data acquired from the third point cloud data by performing preset degradation and real point cloud data collected from a physical space is within a preset difference range.

2. The method of claim 1, further comprising at least one of:
acquiring raw point cloud data collected by a point cloud collecting device from the physical space;
acquiring the first point cloud data by performing point cloud segmentation on the raw point cloud data; or
associating a plurality of frames of the second point cloud data.

3. The method of claim 1, wherein the point cloud completion network is acquired based on the following:
training an initial point cloud completion network based on sample complete point cloud data;
acquiring the third point cloud data which is generated by the trained point cloud completion network based on the target latent space vector;
acquiring the point cloud completion network by optimizing the trained point cloud completion network based on the real point cloud data and the fourth point cloud data.

4. The method of claim 1, wherein
acquiring a plurality of point cloud blocks in the third point cloud data;
for each of the plurality of point cloud blocks, determining a points-distribution feature of the point cloud block;
establishing a loss function based on respective points-distribution features of the plurality of point cloud blocks;
optimizing the trained point cloud completion network based on the loss function.

5. The method of claim 1, wherein
acquiring a plurality of initial latent space vectors sampled from a latent space;
for each of the initial latent space vectors, determining a target function of the initial latent space vector based on point cloud data corresponding to the initial latent space vector and the real point cloud data;
determining the target latent space vector from the initial latent space vectors based on respective target functions of the initial latent space vectors.

6. The method of claim 1, wherein the preset degradation comprises:
for each of a plurality of target points in the real point cloud data, determining one or more points adjacent to the target point in the third point cloud data as neighbor points of the target point;
taking a union of respective neighbor points of the plurality of target points in the real point cloud data as the fourth point cloud data acquired from the third point cloud data by performing preset degradation.

7. A method of processing point cloud data, comprising:
acquiring first to-be-processed point cloud data and second to-be-processed point cloud data in a game area, wherein the first to-be-processed point cloud data corresponds to a game participant and the second to-be-processed point cloud data corresponds to a game object;
acquiring first processed point cloud data by completing the first to-be-processed point cloud data with a point cloud completion network and acquiring second processed point cloud data by completing the second to-be-processed point cloud data with the point cloud completion network;
associating the first processed point cloud data and the second processed point cloud data;
wherein, the point cloud completion network is trained based on complete point cloud data and configured to generate completed point cloud data according to target latent space vector, and a difference between real point cloud data collected from a physical space and degraded point cloud data acquired from the completed point cloud data by performing preset degradation is within a preset difference range.

8. The method of claim 7, wherein the game object comprises a game coin placed into the game area, and the method further comprises, based on the association of the first processed point cloud data and the second processed point cloud data, performing at least one of the following operations:
determining one or more game coins placed by the game participant in the game area;
determining an action performed by the game participant on the game object.

9. The method of claim 7, wherein acquiring the first to-be-processed point cloud data and the second to-be-processed point cloud data comprises:
acquiring raw point cloud data collected by a point cloud collecting device set around the game area;
acquiring the first to-be-processed point cloud data corresponding to the game participant and the second to-be-processed point cloud data corresponding to the game object by performing point cloud segmentation on the raw point cloud data.

10. The method of claim 7, wherein
the point cloud completion network is configured to complete at least one of: the first to-be-processed point cloud data corresponding to game participants of a plurality of categories or the second to-be-processed point cloud data corresponding to game objects of a plurality of categories; or
the point cloud completion network comprises:
a first point cloud completion network configured to complete the first to-be-processed point cloud data corresponding to a game participant of a first category, and
a second point cloud completion network configured to complete the second to-be-processed point cloud data corresponding to a game object of a second category.

11. A computer device, comprising:
at least one processor; and
one or more memories coupled to the at least one processor and storing programming instructions for execution by the at least one processor to perform operations for completing point cloud data, the operations comprising:
acquiring first point cloud data;
acquiring second point cloud data by completing the first point cloud data with a point cloud completion network;
wherein, the point cloud completion network is trained based on complete point cloud data and configured to generate third point cloud data according to target latent space vector, and a difference between fourth point cloud data acquired from the third point cloud data by performing preset degradation and real point cloud data collected from a physical space is within a preset difference range.
